(19) United States
(12) Patent Application Publication
(10) Pub. No.: US 2016/0327314 A1
(43) Pub. Date: Nov. 10, 2016

(54) Method For Adjusting The Maximum Cooling Temperature of a Cooling Element of a User Electrical Appliance and User Electrical Appliance

(71) Applicant: Braun GmbH, Kronberg (DE)

(72) Inventor: Jan Christian Langsdorf, Oberursel (DE)

(21) Appl. No.: 15/145,933

(22) Filed: May 4, 2016

(30) Foreign Application Priority Data
May 8, 2015 (EP) 15166942.1

(51) Int. Cl. F25B 21/04; B26B 19/48; B26B 19/38

(52) U.S. Cl. CPC F25B 21/04; B26B 19/382; B26B 19/3873; B26B 19/48

(57) ABSTRACT

A method and a user electrical appliance for switching on a function of a user electrical appliance having a cooling element are described, wherein the cooling element is coming into contact with the users skin during regular use of the electrical appliance and wherein the cooling element is connected to a thermo element having a cold side and a warm side, the cold side of the thermo element being in thermoconducting contact with the cooling element and the warm side of the thermo element being in thermoconducting contact with a heat reservoir element of the user electrical appliance. The method comprises the following steps:
(a) measuring a voltage induced by the thermo element;
(b) determining whether the measured voltage is above a determined threshold;
(c) activating the function if the measured voltage is above the determined threshold.

### FIELD OF THE INVENTION

The invention relates to a method for switching on a function of a user electrical appliance having a cooling element, wherein the cooling element is coming into contact with the user's skin during regular use of the electrical appliance and wherein the cooling element is connected with a thermo element having a cold side and a warm side. The cold side of the thermo element is in thermoconducting contact with the cooling element and the warm side of the thermo element is in thermoconducting contact with a heat reservoir element of the user electrical appliance. Preferably, the user electrical appliance can be a hair removal device, such as a razor or an epilator.

### BACKGROUND OF THE INVENTION

It is known to have razors with a cooling element for cooling the human skin during the shave. This is pleasant for the user and reduces skin irritations. The DE 1 143 128 B describes a cooling element based on a ventilator leading an airflow towards the skin. In the DE 10 2008 032 150 A1 a respective electrical razor is disclosed having a thermo element for cooling a cooling element in the smear head coming into contact with the user's skin during use.

### SUMMARY OF THE INVENTION

It is an object of the present invention to provide a method for switching on a function of a user electrical appliance in order to enhance the comfort for the user and/or secure the activation of certain function during the use.

This object is achieved with the features of the independent claims. According to claim 1 it is provided to

(a) measuring a voltage induced by the thermo element;

(b) determining whether the measured voltage is above a determined threshold;

(c) activating the function if the measured voltage is above the determined threshold.

A respective user electrical appliance according to claim 9 has a microprocessor adapted to perform the above defined steps.

The cooling the cooling element is performed in line with the invention by an actuation of the thermo element with a DC voltage applied to the thermo element with the same polarity used during normal use of the user electrical appliance. This is advantageous because no revering of polarity with respect to the thermo element is necessary. The thermo element is preferably a known peltier element. However, the thermo element can also be realized with any other element producing a temperature difference between one and the other side of the thermo element, e.g. using semiconductor elements.

A reverse effect of such a thermo element is the generation a voltage between the cold side and the warm side of the thermo element if there is induced a temperature difference between the cold side and the warm side when the thermo element is not in use. This effect is known as Seebeck effect. Normally, the cold side and the warm side will adopt—at least after a certain time after use for heat dissipation form the warm side and warming of the cold side—the ambient temperature of the user electrical alliance if the appliance is not in use. If the user starts to use the appliance by bringing the cooling element into contact with his or her skin, the cold side (having the ambient temperature being under normal circumstances lower than the user's skin temperature) begins to heat up contrary to the warm side keeping the ambient temperature. This temperature difference induces a voltage over the thermo element that can be detected.

If the induced voltage is above a determined threshold, a certain function of the user electrical appliance is activated. Providing a determined (voltage) threshold has the advantage that minor fluctuations e.g. due the background noise or minor temperature differences between the cold and warm side of the user electrical appliance. In order to distinguish such random events from user activated events that shall lead to the activation of certain functions, the determined threshold is used. In a simple and easy-to-implement embodiment of the invention, the threshold can fixed in a control of the device, in particular a microcontroller, upon production of the device.

Thus it is possible to securely identify a user induced event of the appliance and to activate a certain function of the appliance in reaction to the user induced event.

According to a preferred embodiment, the activated function is the actuation of the cooling element. Thus, the—energy consuming cooling of the cooling element—is activated (preferably only) when the cooling element is in abutment against the user's skin. Only in this case, the cooling function of the device is necessary. The activation of this function might be stop when the user switches off the device.

Additionally or alternatively, the activated function might be the switching on of the user electrical appliance. This might comprise the activation of all functions necessary for an ordinary or standard use of the appliance. In the case of a razor or epilator, this might be the activation of the motor of the hair removal device for cutting or plucking hairs and of the cooling element for cooling the skin in the area of treatment. Again, the activation of this function might be stop when the user switches off the device.

In order to use the measured voltage in the control process, e.g. for comparing with the determined threshold, measuring the voltage induced by the thermo element might preferably include converting the analog voltage signal to a digital voltage value. Then, the control of the user electrical appliance can be performed in a simple microprocessor. No logic of the control process has to be built by an analog electric circuit.

Irrespective of how the measured voltage is processed and compared with the determined threshold that can be a predetermined (analog or digital) voltage value, the determined threshold can according to a preferred embodiment be dynamically set in dependence of a measured ambient temperature. For the measuring the ambient temperature, there might be provided a separate temperature sensor in the casing of the user electrical appliance. This separate temperature sensor might be in thermoconducting contact with the heat reservoir element and additionally used in method for adjusting the maximum cooling temperature of a cooling element as reference temperature. Dynamically setting of the determined (voltage) threshold means that the threshold is set in dependence of other actually determined criteria, in contrast to a fixed predetermined value. Such dynamic threshold will enhance the identification of the certain user activated event, e.g. bringing the cooling element in contact with the cooling element. In a cold environment, also the user's skin might be colder leading to a lower temperature difference between the cold and the warm side of the thermo element. Then it is useful to adapt the threshold accordingly.

Another possibility to enhance the recognition of the certain user activated event might be in line with the invention an activating of the function is dependent on the change rate of the measured voltage. With this feature, a time dependence of the measured voltage is used to identify a user event. This might also be combined with the before aspect of measuring e.g. the ambient temperature.

As a preferred example one might consider the following user event. The user brings the cooling element of a razor or epilator into contact with his skin. The ambient temperature of the razor or epilator, or more generally the user electrical appliance in a household environment, might be in a variation range about 20° C. In the same environment, a typical skin temperature might be in the order of about 32° C. to 35° C. Taking into account a typical and known contact between skin and cooling element leading to a defined heat-transfer coefficient, the time behavior of the warming of the cool side through the contact of the cooling element and the skin can be predicted. As a certain temperature is correlated with a certain voltage induced by thermo element, the time behavior for this event is known. The time behavior can be evaluated by a determination of the change rate of the measured voltage. This determined change rate might then be one criterion for activating the function.

In order to determine the change rate of the measured voltage it is proposed according to a preferred embodiment that the voltage induced by the thermo element is measured in regular time intervals and that the change rate is determined by the change of the measured voltage from the beginning to the end of one of time interval wherein the change rate is determined for several consecutive time intervals thus determining a change rate curve.

This change rate curve allows to compare the change rate time behavior of the actual measured voltage to a to a predetermined, theoretical or empirical, change rate curve induced when human skin comes in contact with the cooling element. This allows a better and more reliable identification of the situation that human skin is coming in contact with the cooling element. The predetermined (theoretical or empirical) change rate curve might be chosen form a set of predetermined curves for different ambient temperatures according to the actually measured ambient temperature.

Advantageously, a user electrical appliance is provided, in particular a hair removal device such as a razor or an epilator, having an electrical motor for driving an actuator of the user electrical appliance, the actuator being e.g. a hair removal tool such as a smear head or a pluck roll. Further, the electrical appliance comprises a power supply and a cooling element coming in contact with the user's skin during regular use of the electrical appliance. The cooling element itself comprises a thermo element having a cold side and a warm side, the cold side of the thermo element being in thermoconducting contact with the cooling element and the warm side of the thermo element being in thermoconducting contact with a heat reservoir element of the user electrical appliance. Further, a microprocessor adapted for controlling the actuation of the motor and the thermo element is provided. In line with the invention, the thermo element is connected to a measuring port of the microcontroller to measure the voltage induced by the thermo element and the microcontroller is adapted to perform the method as described before or parts thereof. The microcontroller can be any suited processor included in the user electrical appliance and adapted to perform all or any selection of the proposed method steps. The adaption of the processor can be achieved by implementing program code means in executable form on the processer such that when executed on the processor the proposed method or parts thereof are executed.

The measuring port of the microprocessor might be an ADC-input port that directly converts an analog voltage input signal to a digital input voltage signal. Accordingly, the voltage signal is directly converted into a digital value that can be processed by software implemented on the microprocessor. The digital value can thus directly be compared with the determined threshold. Further, the digital values can directly be used to calculate the change rate between to measured voltage values using an internal clock of the microprocessor for determining the time between the two measured values. By adding the change rates to a list containing the change rate and the time of the change rate, the temporal behavior of the change rate can be determined from the measured value. The activation of the function of the user appliance can be dependent of the change rate as criterion as well. To this aim, the change rate after a certain time from the first voltage determined or a defined temporal behavior of the change rate can be used as criterion.

The measuring port of the microcontroller might be arranged in parallel to an actuation port of the microcontroller to actuate the thermo element by applying a controlled voltage and current to the thermo element. The actuation of the thermo element leads to a cooling of the cooling element during regular use of the user electrical appliance.

Advantageously, the measuring port and the actuation port of the microcontroller can be activated or switched separately. This is a common technique of microcontrollers. The one skilled in the art might choose an appropriate type of microcontroller from the known variety of available microcontrollers. Preferably, the measuring port of the appliance attached to the thermo element for measuring the voltage induced by the thermo element might be an interrupt port of the microprocessor. The interrupt port is a port of the microprocessor that is active also in a stand-by modus of the microprocessor sensing the applied voltage. As soon as a voltage is sensed at the port, the microprocessor is set into an operation mode. This is useful to save energy during the rest time of the user electrical appliance, in particular if the appliance is battery driven.

For additionally measuring the ambient temperature of the device, the user electrical appliance might comprise a temperature sensor. This temperature sensor might be in thermoconducting contact with the heat reservoir element and connected to a (different) measuring port of the microcontroller. Also the measured ambient temperature might be used as an additional criterion for the decision to switch on the select function or functions (including switching on the appliance).

The measuring port might be in parallel to an actuation port of the microcontroller to actuate the thermo element by applying a controlled voltage and current to the thermo element. Advantageously the measuring port and the actuation port of the microcontroller can be activated or switched separately (e.g. if the measuring port is an interrupt suited port). This is a common technique of microcontrollers. The one skilled in the art might choose an appropriate type of microcontroller from the known variety of available microcontrollers.

### BRIEF DESCRIPTION OF THE DRAWINGS

FIG. 1 shows schematically sectional view of a user electrical appliance according to a preferred embodiment of the invention.

FIG. 2 shows flow process chart of a method for switching on a function of a user electrical appliance of the user electrical appliance according to a preferred embodiment of the invention.

### DETAILED DESCRIPTION OF THE INVENTION

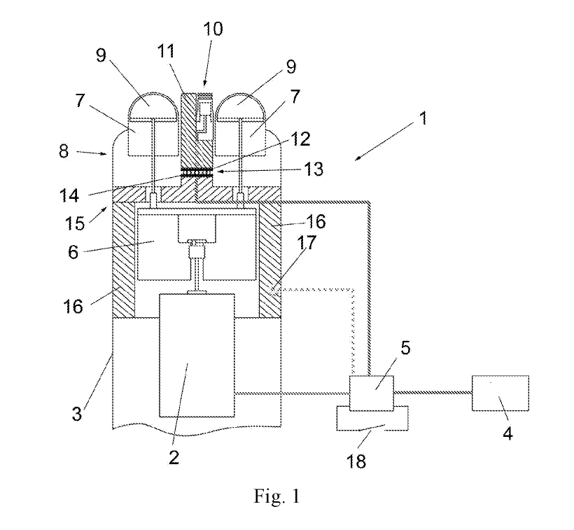

FIG. 1 shows a user electrical appliance 1 according to the present invention by means of an electrical razor as a preferred example for a user electrical appliance. Preferred embodiments of the invention are related to hair removal tools, such as razors or epilators. However, the inventions also relates to any user electrical appliance parts of which are provided for a direct contact with the user's skin. In the following, the terms “razor” and “user electrical appliance” are used as equivalents.

The razor as user electrical appliance 1 has motor 2 in a casing 3 of the razor 1. The motor 2 is powered by secondary batteries (not shown) that can be charged by a charger 4 under the control of a microprocessor 5. This means that a program code was implemented in the microprocessor 5 that—when executed by the microprocessor 5—performs the necessary control steps. In this particular case, control steps for charging the secondary batteries. This is well known to the one skilled in the art and similar for all battery driven user electrical appliances.

The motor 2 is driving at least one actuator 6 for performing a certain action of the user electrical appliance 1, mostly correlated with the function of the appliance. In case of the razor 1, the actuator 6 is actuating a smear element 7 (or as shown in FIG. 1 two smear elements 7) in the smear head 8 for cutting hairs of the beard with respective blades 9. This technique is well known, and there are different constructional possibilities for realizing the actuator 6 and the smear head 8. Additionally, the razor 1 according to the example of FIG. 1 comprises a further cutting element 10, which might be used as a longhair cutter. These cutting elements 10 are regularly also motor driven and of known technology. Therefore, these elements are not explained in detail in the context of the invention. The invention relates to all possible realizations of the smear heads 8 and/or cutting elements 10 of razors as user electrical appliances 1.

According to the invention, the user electrical appliance 1, i.e. the razor in the example shown in FIG. 1, comprises a cooling element 11 disposed such in the electrical appliance 1 that it comes into contact with the user's skin during a regular use of the electrical appliance 1. For a razor, it is accordingly advantageous to dispose the cooling element 11 in the smear head 8 which is contacting the user's skin during cutting the hair of the beard. Depending on the type of the user electrical appliance, the one skilled in the art will dispose the cooling element 11 in an advantageous position. The invention is not limited to a certain position of the cooling element 11 as long as it comes in direct contact with the skin of the user during a regular use.

The cooling element 11 is in thermoconducting contact with the cold side 12 of a thermo element 13 that cools down its cool side 12 when actuated. Normally, for actuation of the thermo element 13, a respective voltage and current are applied to the thermo element 13. The thermo element 13 can be a peltier element well known in the art. When a current is flowing through the peltier element (or more generally the thermo element 13) it cools down its cold side 12 and contemporaneously heats its warm side 14.

With a certain voltage and current applied to the thermo element 13, the thermo element 13 produces a defined temperature difference between its cold side 12 and its warm side 14. As the cooling element 11 is in thermoconducting contact with the cold side 12 of the thermo element 13, cooling elements 11 adopts the temperature of the cold side 12 and is able to cool the user's skin when the skin comes in contact with the cooling element 11.

In order to conduct the warmth produced at the warm side 14 of the thermo element 13 away from the thermo element 13 and to avoid strong heating of the warm side 14 to very high temperatures (thereby reducing the maximum cooling temperature on the cold side 12) there is provided a heat reservoir element 15 in thermoconducting contact with the warm side of the thermo element 13. Accordingly, the heat reservoir element 15 absorbs the warmth and conducts it away from the warm side 15. To this aim, the heat reservoir element 15 is preferably of much higher mass than the warm side 14 of the thermo element 13. Accordingly, the warmth is distributed to a large corpus that is only slowly getting warmer. This is helpful as the regular time of use of the user electrical appliances 1, such as a razor or similar hair removal tool, is quite short. So, the heat reservoir element 15 is not heated very much.

Further, it is advantageous that parts 16 of the heat reservoir element 15 built a part of the outer casing of the user electrical appliance 1. Then the heat absorbed from the heat reservoir element 15 can easily be dissipated to the environment.

Both, the cooling element 11 and the heat reservoir element 15 are built of thermoconducting material, such as metal or thermoconducting plastic.

On the other hand, when the thermo element 13 is not actuated for cooling down the cooling element 11, there is normally no temperature difference between the cold side 12 and the warm side 14 of the thermo element 13. If—without actuation the thermo element 13—the cooling element 11 is warmed e.g. in contact with the user's skin, the cold side 12 of the thermo element 13 is warming up. It is getting warmer than the warm side 14 of the thermo element 13. In this condition, a voltage is induced by the thermo element 13. This is known as Seebeck effect.

The microprocessor 5 is used to control the functions of the user electrical appliance 1. It switches on the motor 2 when the user turns on the appliances and applies a DC voltage and current to the thermo element. This is schematically shown in FIG. 1 by the one-line-connections between the microprocessor 5 and the motor 2 or the thermo element 13, respectively. However, a single line might comprise two conductor lines, as the one skilled in the art understands.

The invention is now proposing an alternative or additional way to switch on functions of the user electrical appliance, such as switching on the motor 2 and/or the cooling element 11. To this aim, the microprocessor 5 comprises a measurement port also connected to the thermo element 13. This is schematically also shown by the one-line-connection between microprocessor 5 and thermo element 13. However, there might be provided a separate conducting line form the thermo element 13 to the measuring port of the microprocessor 5.

This measuring port might include directly an ADC (Analog Digital Converter) to convert the analog voltage signal induced by the thermo element 13 into a digital voltage value that can be used directly by the microprocessor to within its control routine, e.g. to compare with a threshold. Further, measuring port might be an interrupt port of the microprocessor 5 awaking the microprocessor from a stand-by mode to an operational mode upon applying a voltage to the measuring port. This voltage can then be discriminated for the decision to activate a certain function of the user electrical appliance. Such discriminator compares the measured voltage with a determined threshold and gives a signal it the measured voltage exceeds the determined voltage. This signal is then used by the microprocessor to activate the function. This is indicated in FIG. 1 by the switch 18.

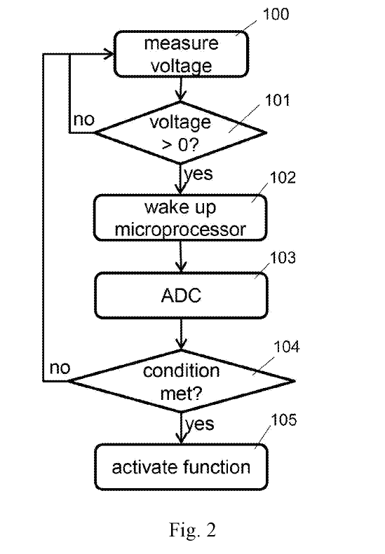

In the following, a preferred embodiment of the proposed method is described with respect to FIG. 2.

The method starts with the measurement of the voltage induced by the thermo element 13 in step 100. A voltage is induced only if the there is a temperature difference between the cold side 12 and the warm side 14 of the thermo element 13. Preferably, the voltage is measured at a measurement port of the microprocessor 5 connected to the thermo element 13 such that induced the voltage of the thermo element 13 is positive if the cold side 12 is warmer than the warm side 14. This is achieved by connecting one specific side of the thermo element 13 to the respective measuring port of the microprocessor 5.

This measuring port of the microprocessor 5 is—in the embodiment explained—an interrupt port of the microprocessor 5. The interrupt port is configured by implementation of suited software such that the microprocessor 5 will automatically switch from a stand-by mode to an operation mode. Suited microprocessors are known in the art. As long as no voltage is induced, the microprocessor remains in the stand-by mode waiting for a voltage value above zero applied to interrupt measurement port.

If such voltage above zero is sensed at the interrupt port as indicated in step 101, the microprocessor wakes up in step 102 and performs the following method steps. First, the measurement port converts the analog voltage signal to a digital voltage value in step 103 being an analog-digital converter.

In the following step 104 according to a preferred embodiment of the invention, it is checked whether the measured voltage value meets the condition or conditions for activation a function of the user electric appliance. This comprises comparing the actual digitalized voltage value with a predetermined threshold as described above. The threshold might be chosen such that an exceeding of the threshold is indicative of human skin being in contact with the—so far non actuated—cooling element 11.

In this case, the desired function of the user electric device 1 is activated (step 105). This function can be the actuation of the thermo element 13 to cool the cooling element 11 and/or the actuation of the motor 2 to start shaving. Else, the process returns to measure the voltage in step 100.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Method for switching on a function of a user electrical appliance having a cooling element, wherein the cooling element is coming into contact with the users skin during regular use of the electrical appliance and wherein the cooling element is connected to a thermo element having a cold side and a warm side, the cold side of the thermo element being in thermoconducting contact with the cooling element and the warm side of the thermo element being in thermoconducting contact with a heat reservoir element of the user electrical appliance, wherein the method comprising the following steps:
(a) measuring a voltage induced by the thermo element;
(b) determining whether the measured voltage is above a determined threshold;
(c) activating the function if the measured voltage is above the determined threshold.

2. Method according to claim 1, wherein the activated function is actuation of the cooling element.

3. Method according to claim 1, wherein the activated function is switching on of the user electrical appliance.

4. Method according to claim 1, wherein measuring the voltage induced by the thermo element includes converting the analog voltage signal to a digital voltage value.

5. Method according to claim 1, wherein the determined threshold is set in dependence of a measured ambient temperature.

6. Method according to claim 1, wherein the activating of the function is dependent on the change rate of the measured voltage.

7. Method according to claim 6, wherein the voltage induced by the thermo element is measured in regular time intervals and that the change rate is determined by the change of the measured voltage from the beginning to the end of one of time interval wherein the change rate is determined for several consecutive time intervals thus determining a change rate curve.

8. Method according to claim 7, wherein change rate curve is compared to a predetermined change rate curve induced when human skin comes in contact with the cooling element.
